(19) United States
(12) Patent Application Publication
(10) Pub. No.: US 2020/0220846 A1
(43) Pub. Date: Jul. 9, 2020

(54) Automation and/or Communications Appliance and Method for Checking Datagrams Transmitted in An Industrial Automation System

(71) Applicant: SIEMENS AKTIENGESELLSCHAFT, München (DE)

(72) Inventor: Wolfgang SCHWERING, Röttenbach (DE)

(73) Assignee: Siemens Aktiengesellschaft, München (DE)

(21) Appl. No.: 16/642,701

(22) PCT Filed: Aug. 27, 2018
(86) PCT No.: PCT/EP2018/072973

§ 371 Date: Feb. 27, 2020

(30) Foreign Application Priority Data
Aug. 30, 2017 (EP) 17188511.4

(51) Int. Cl. H04L 29/06; G05B 19/418; G06F 9/455

(52) U.S. Cl. CPC H04L 63/0263; H04L 63/162; H04L 63/029; G06F 2009/4557; G06F 9/45558; G06F 2009/45595; G05B 19/4185

(57) ABSTRACT

Method for checking datagrams transmitted in an industrial automation system containing a plurality of automation cells, wherein datagrams to be checked are transmitted out of the automation cells via a respective firewall interface to check the firewall system and the datagrams are then checked in a rule-based manner, where the firewall system is formed by at least one virtual machine provided in a data processing system comprising a plurality of computer units, for transmission of the datagrams to be checked, a data link layer tunnel is respectively built between each firewall interface and the firewall system, and where both datagrams to be checked and at least successfully checked datagrams are transmitted inside the respective data link layer tunnel.

### CROSS-REFERENCE TO RELATED APPLICATIONS

This is a U.S. national stage of application No. PCT/EP2018/072973 filed Aug. 27, 2018. Priority is claimed on EP Application No. 17188511 filed Aug. 30, 2017, the content of which is incorporated herein by reference in its entirety.

### BACKGROUND OF THE INVENTION

### 1. Field of the Invention

The present invention relates to industrial automation system and, more particularly, to a device and method for efficiently checking datagrams transmitted within an industrial automation system comprising a plurality of automation cells.

Industrial automation systems serve to monitor, control and regulate technical processes, particularly in the manufacturing automation, process automation and building automation sectors, and enable an operation of control devices, sensors, machines and industrial plants that is intended to occur as autonomously and as independently from human intervention as possible. A provision of monitoring, control and regulation functions in real time is of particular importance here. Faults in communications links between automation devices or computer units of an industrial automation system can result in a disadvantageous repetition of the transmission of a service request. In particular, messages that are not transmitted or are not completely transmitted can prevent a transition to or continuation of a safe operating state of an industrial automation system and can result in a failure of an industrial plant. Particular problems occur in industrial automation systems due to message traffic with relatively numerous but relatively short messages that are to be transmitted in real time.

### 2. Description of the Related Art

U.S. Pat. No. 8,555,373B2 discloses a firewall provided between a source device, comprising a hardware security component for checking data extracted from a data packet against a permissible list. In addition, the hardware security component performs a standards-based check in relation to a protocol. The firewall can be designed as a security proxy and can enable sessions between two participants via a software security component. The software security component makes use of the hardware security component for authentication and decryption of packets that are to be checked and for encryption of checked packets.

U.S. Pat. No. 7,958,549B2 describes a firewall with an encryption processor and a virtualized server. The encryption processor is connected upstream of the virtualized server and decrypts encrypted data packets that are then forwarded to the virtualized server for processing. In the opposite direction, the encryption processor receives data packets processed by the virtualized server in order to encrypt this forwarding.

EP 2 464 059 A1 relates to an automation system with a first switching network node for a communications network. The first switching network node comprises a multiplicity of input ports and output ports and a multiplicity of integrated security components that are designed to restrict communication between the input ports and the output ports. The security components are freely interconnectable as required with the input ports and the output ports. In addition, the automation system has a system bus and a multiplicity of automation cells. Each of the automation cells has a second switching network node. The communication between the second switching nodes of the automation cells and the system bus is restricted exclusively by the security components of the first switching node. The second switching nodes only comprise switch functions. Consequently, the first switching network node cannot be disposed outside the automation system, but must be connected to the second switching network nodes via a system bus. This results in scaling disadvantages in relation to use of centralized firewall functions.

In industrial automation systems, networking of multiple factories is becoming increasingly important. Autonomously operated automation cells are sometimes interconnected via an industrial communications network in the sense of a backbone at control level. The industrial communications network is preferably designed as an IP communications network (OSI Layer 3) based on availability and scalability requirements. In particular, the need exists for individual automation cells to be secured against one another and for access across cells to be largely restricted. In addition, requirements also exist for monitoring transitions between industrial communications networks, on the one hand, and general company-wide communications networks, on the other hand via firewall mechanisms.

### SUMMARY OF THE INVENTION

In view of the foregoing, it is therefore an object of the present invention to provide a device and method for efficiently checking datagrams transmitted within an industrial automation system comprising a plurality of automation cells.

This and other objects and advantages are achieved in accordance with the invention by an automation and communications appliance for an industrial automation system and by a method for checking datagrams transmitted within the industrial automation system, where the automation system comprises a plurality of automation cells that are interconnected via an industrial communications network and each comprise a firewall interface and a plurality of automation appliances. The firewall interfaces may, for example, each be integrated into a controller or router of the respective automation cell. Datagrams to be checked are transmitted from the automation cells via the respective firewall interface for checking to a firewall system connected at least indirectly to the industrial communications network and are checked there in a rule-based manner. The firewall system is formed by at least one virtual machine provided within a data processing system comprising a plurality of computer units. The firewall system advantageously checks datagrams transmitted by the firewall interfaces of the automation cells based on defined security rules, transmits successfully checked datagrams back to the respective firewall interface or to a firewall interface of a destination automation cell and rejects datagrams that do not comply with the defined security rules.

In accordance with the invention, a data link layer tunnel is set up (established) between each respective firewall interface and the firewall system to transmit the datagrams to be checked. Not only datagrams to be checked, but also at least successfully checked datagrams are transmitted within the respective data link layer tunnel. The datagrams are preferably each transmitted in encrypted form within the data link layer tunnels. Transmitted datagrams are each encapsulated within the data link layer tunnels into a tunnel datagram that comprises a network layer header and a transport layer header along with the respective datagram, and are transmitted via a transport layer connection between the respective firewall interface and the firewall system. A good scalability and a simplified configuration result from the present virtualized and distributed firewall system, in particular due to the firewall interfaces.

The industrial communications network may, for example, be a first subnetwork that is secured against access from a second IP-based subnetwork, in particular a general company-wide or organization-wide communications network, and is connected via a router to the second subnetwork. The data processing system that provides the virtual machine forming the firewall system can be connected to the second subnetwork and can therefore be used as a company-wide or organization-wide data center.

In accordance with one preferred embodiment of the present invention, the firewall interfaces are each redundantly configured and are connected to the firewall system according to the Virtual Router Redundancy Protocol (VRRP). In addition, the automation cells can each advantageously be redundantly connected to the industrial communications network in accordance with the Rapid Spanning Tree Protocol, High-availability Redundancy Protocol or Media Redundancy Protocol.

In accordance with a further advantageous embodiment of the present invention, the datagrams are each transmitted within the data link layer tunnels via an unsecured transport layer connection between the respective firewall interface and the firewall system. The datagrams are each preferably transmitted within the data link layer tunnels between the respective firewall interface and the firewall system in accordance with the User Datagram Protocol, so that time-critical data traffic also suffers no appreciably negative effects. According to one preferred development, the data link layer tunnels between the respective firewall interface and the firewall system are set up in accordance with Internet Engineering Task Force (IETF) Request for Comments (RFC) 7348.

The automation and communications appliance in accordance with the invention for an industrial automation system is provided to implement the method in accordance with the preceding description and comprises a firewall interface and is assigned to an automation cell of the automation system comprising a plurality of automation appliances. The automation cell is connected to an industrial communications network. The automation and communications appliance is configured to transmit datagrams to be checked from the automation cell via the firewall interface for checking to a firewall system connected at least indirectly to the industrial communications network.

In accordance with the invention, the automation and communications appliance is configured to set up (establish) a data link layer tunnel between the firewall interface and the firewall system to transmit the datagrams to be checked. The automation and communications appliance is furthermore configured to transmit not only datagrams to be checked, but also at least successfully checked datagrams within the data link layer tunnel. In addition, the automation and communications appliance is configured to encapsulate datagrams transmitted within the data link layer tunnel into a tunnel datagram that comprises a network layer header and a transport layer header along with the respective datagram, and transmit the encapsulated datagrams via a transport layer connection between the respective firewall interface and the firewall system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in detail below on the basis of an example embodiment with reference to the drawing, in which:

FIG. 1 is a schematic block diagram of an industrial automation system with a plurality of automation cells that are interconnected via an industrial communications network in accordance with the invention; and

FIG. 2 is a flowchart of the method in accordance with the invention.

### DETAILED DESCRIPTION OF THE EXEMPLARY EMBODIMENTS

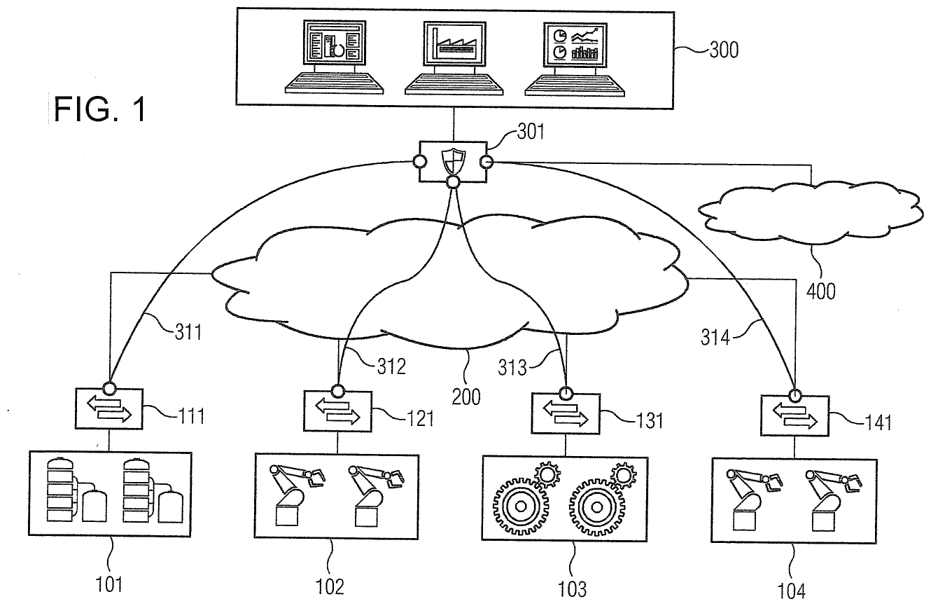

The industrial automation system shown in FIG. 1 comprises a plurality of automation cells 101, 102, 103, 104 that are interconnected via an industrial communications network 200 and that each comprise a firewall interface 111, 121, 131, 141 and a plurality of automation appliances. The firewall interfaces 111, 121, 131, 141 may, for example, each be integrated into a controller or into a network component, in particular into a router, switch, gateway or access point, of the respective automation cell 101, 102, 103, 104. The automation appliances may, in particular, be input/output units, programmable logic controllers or PC-based controllers of a machine or a technical plant, such as a robot or conveying device.

Programmable logic controllers each typically comprise a communications module, a central unit and at least one input/output unit (I/O module). Input/output units may essentially also be formed as local peripheral modules that are disposed remotely from a programmable logic controller. The input/output units serve to exchange control and measurement parameters between the respective automation appliance and a machine or device controlled by the automation appliance. The central units of the automation appliances are provided, in particular, for determining suitable control parameters from recorded measured quantities. The programmable logic controllers can be connected via the communications modules, for example, to a switch or router or additionally to a fieldbus. The above components of a programmable logic controller are preferably interconnected via a backplane bus system.

The firewall interfaces 111, 121, 131, 141 are, each configured to transmit datagrams to be checked from the respective automation cell 101, 102, 103, 104 for checking to a firewall system 301 connected to the industrial communications network 200. The datagrams to be checked from the automation cells 101, 102, 103, 104 can be checked by the firewall system 301 in a rule-based manner. In the present exemplary embodiment, the firewall system 301 is formed by at least one virtual machine provided within a data processing system 300 comprising a plurality of computer units. The firewall system 301 can be provided, for example, via a hypervisor that serves as a hardware abstraction element between actually present hardware and at least one executable operating system installable for the firewall system. A hypervisor of this type enables a provision of a virtual environment that comprises partitioned hardware resources, such as processors, memories or peripheral devices. Instead of a hypervisor, other known virtualization concepts can essentially also be used as hardware abstractions for the provision of the firewall system 301.

The firewall system 301 checks datagrams transmitted by the firewall interfaces 111, 121, 131, 141 of the automation cells 101, 102, 103, 104 based on defined security rules and transmits successfully checked datagrams back to the respective firewall interface 111, 121, 131, 141 or to a firewall interface of a destination automation cell. In the present exemplary embodiment, datagrams that do not comply with the defined security rules are rejected by the firewall system 301. The security rules preferably comprise standard firewall rules. The security rules may additionally comprise rules relating to the reliability of control commands or control parameters indicated in datagrams for automation appliances of the industrial automation system. The industrial communications network 200 thus offers security-monitored access facilities to the automation appliances in the automation cells 101, 102, 103, 104.

In addition, the firewall interfaces 111, 121, 131, 141 are each configured to set up (establish) a data link layer tunnel 311, 312, 313, 314 between the respective firewall interface 111, 121, 131, 141 and the firewall system 301 to transmit the datagrams to be checked. Not only datagrams to be checked, but also at least successfully checked datagrams are transmitted within the respective data link layer tunnel 311, 312, 313, 314. Datagrams transmitted within the data link layer tunnels 311, 312, 313, 314 are each encapsulated into a tunnel datagram that comprises a network layer header, in particular an Internet Protocol (IP) header and a transport layer header, in particular a User Datagram Protocol (UDP) header, along with the respective datagram. The tunnel datagrams are transmitted in each case via a transport layer connection between the respective firewall interface 111, 121, 131, 141 and the firewall system 301. The data link layer tunnels between the respective firewall interface and the firewall system are preferably set up (established) in accordance with IETF RFC 7348 (VXLAN—Virtual eXtensible Local Area Network).

In the present exemplary embodiment, the datagrams are each transmitted within the data link layer tunnels 311, 312, 313,314 in encrypted form. In particular, the datagrams can be each transmitted within the data link layer tunnels 311, 312, 313, 314 via an unsecured transport layer connection between the respective firewall interface 111, 121, 131, 141 and the firewall system 301. The datagrams are preferably transmitted within the data link layer tunnels 311, 312, 313, 314 between the respective firewall interface 111, 121, 131, 141 and the firewall system 301 in each case according to the User Datagram Protocol (UDP).

In the present exemplary embodiment, the industrial communications network 200 is a first subnetwork that is secured against access from a second IP-based subnetwork 400, in particular from a general company-wide communications network, and is connected via a router to the second subnetwork 400. The firewall system 301 and the router are combined into one integrated unit. To simplify the representation, the router is not shown as a separate unit in FIG. 1. The data processing system 300 that the virtual machine forming the firewall system 301 provides can essentially also be connected to the second subnetwork 400 only and does not therefore require a direct connection to the industrial communications network 200.

The firewall interfaces 111, 121, 131, 141 can furthermore each be redundantly configured and can be connected to the firewall system 301 in accordance with to the Virtual Router Redundancy Protocol (VRRP). In addition, the automation cells 101, 102, 103, 104 can each be redundantly connected to the industrial communications network 200 in accordance with the Rapid Spanning Tree Protocol (RSTP), High-availability Redundancy Protocol (HSR) or Media Redundancy Protocol (MRP).

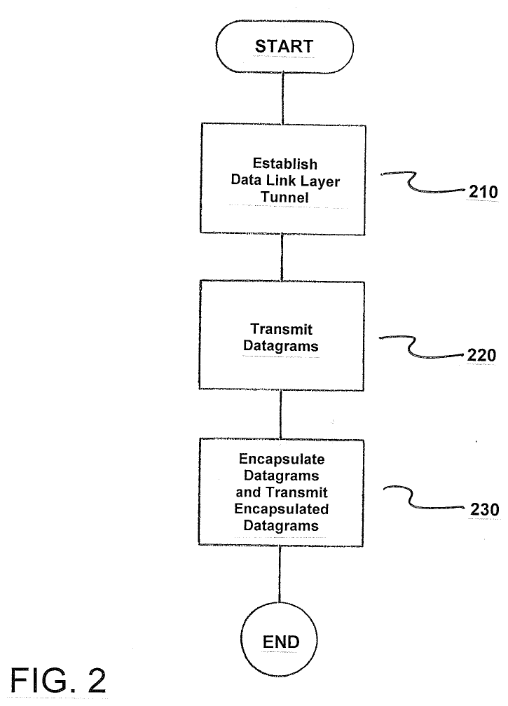

FIG. 2 is a flowchart of a method for checking datagrams transmitted within an industrial automation system comprising a plurality of automation cells 101, 102, 103, 104 that are interconnected via an industrial communications network 200 and that each comprise a firewall interface 111, 121, 131, 141 and a plurality of automation appliances, where datagrams to be checked are transmitted from the plurality of automation cells 101, 102, 103, 104 via a respective firewall interface 111, 121, 131, 141 for checking to a firewall system 301 connected at least indirectly to the industrial communications network 200 and are checked at the firewall system 301 in a rule-based manner, and where the firewall system 301 being formed by at least one virtual machine provided within a data processing system 300 comprises a plurality of computer units.

The method comprises establishing a data link layer tunnel 311, 312, 313, 314 between each respective firewall interface 111, 121, 131, 141 and the firewall system 301 to transmit the datagrams to be checked, as indicated in step 210.

Next, at least successfully checked datagrams are transmitted along with datagrams to be checked within the respective data link layer tunnel 311, 312, 313, 314, as indicated in step 220.

Next, each datagram transmitted within the data link layer tunnels 311, 312, 313, 314 is encapsulated into a tunnel datagram that comprises a network layer header and a transport layer header along with the respective datagram, and each encapsulated datagram transmitted within the data link layer tunnels 311, 312, 313, 314 is transmitted via a transport layer connection between the respective firewall interface 111, 121, 131, 141 and the firewall system 301, as indicated in step 230.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A method for checking datagrams transmitted within an industrial automation system comprising a plurality of automation cells which are interconnected via an industrial communications network and which each comprise a firewall interface and a plurality of automation appliances, datagrams to be checked being transmitted from the plurality of automation cells via a respective firewall interface for checking to a firewall system connected at least indirectly to the industrial communications network and being checked at the firewall system in a rule-based manner, the firewall system being formed by at least one virtual machine provided within a data processing system comprising a plurality of computer units, the method comprising:
establishing a data link layer tunnel between each respective firewall interface and the firewall system to transmit the datagrams to be checked;
transmitting at least successfully checked datagrams along with datagrams to be checked within the respective data link layer tunnel; and
encapsulating each datagram transmitted within the data link layer tunnels into a tunnel datagram which comprises a network layer header and a transport layer header along with the respective datagram, and transmitting each encapsulated datagram transmitted within the data link layer tunnels via a transport layer connection between the respective firewall interface and the firewall system.

14. The method as claimed in claim 13, wherein the firewall interfaces are each integrated into a controller or router of the respective automation cell.

15. The method as claimed in claim 13, wherein the industrial communications network comprises a first subnetwork which is secured against access from a second IP-based subnetwork and is connected via a router to the second subnetwork.

16. The method as claimed in claim 14, wherein the industrial communications network comprises a first subnetwork which is secured against access from a second IP-based subnetwork and is connected via a router to the second subnetwork.

17. The method as claimed in claim 15, wherein the data processing system which the virtual machine forming the firewall system provides is connected to the second subnetwork.

18. The method as claimed in claim 13, wherein each firewall interface is redundantly configured and is connected to the firewall system in accordance with a Virtual Router Redundancy Protocol.

19. The method as claimed in claim 13, wherein the plurality of automation cells are each redundantly connected to the industrial communications network in accordance with one of (i) a Rapid Spanning Tree Protocol, (ii) High-availability Redundancy Protocol and (iii) Media Redundancy Protocol.

20. The method as claimed in claim 13, wherein the datagrams are each transmitted within the data link layer tunnels in encrypted form.

21. The method as claimed in claim 13, wherein the datagrams are each transmitted within the data transport layer tunnel via an unsecured transport layer connection between the respective firewall interface and the firewall system.

22. The method as claimed in claim 21, wherein the datagrams are each transmitted within the data link layer tunnels between the respective firewall interface and the firewall system in accordance with a User Datagram Protocol.

23. The method as claimed in claim 13, wherein the data link layer tunnels between the respective firewall interface and the firewall system are set up in accordance with Internet Engineering Task Force (IETF) Request for Comments (RFC) 7348.

24. The method as claimed in claim 13, wherein the firewall system checks datagrams transmitted by the firewall interfaces of the automation cells based on defined security rules, transmits successfully checked datagrams back to one of (i) a respective firewall interface and (ii) a firewall interface of a destination automation cell and rejects datagrams which do not comply with the defined security rules.

25. An automation and/or communications appliance for an industrial automation system, comprising:
a firewall interface and is assigned to an automation cell of the automation system comprising a plurality of automation appliances, the automation cell being connected to an industrial communications network;
wherein the automation and/or communications appliance is configured to:
transmit datagrams to be checked from the automation cell via the firewall interface for checking to a firewall system connected at least indirectly to the industrial communications network,
establish a data link layer tunnel between the firewall interface and the firewall system to transmit the datagrams to be checked;
transmit at least successfully checked datagrams along with datagrams to be checked within the data link layer tunnel; and
encapsulate datagrams transmitted within the data link layer tunnel into a tunnel datagram which comprises a network layer header and a transport layer header along with the respective datagram, and transmit said encapsulated datagrams transmitted within the data link layer tunnel via a transport layer connection between the firewall interface and the firewall system.
